(19) United States
(12) Patent Application Publication
(10) Pub. No.: US 2026/0149947 A1
(43) Pub. Date: May 28, 2026

(54) GEOFENCED-BASED INTERFACE GENERATION

(71) Applicant: Walmart Apollo, LLC, Bentonville, AR (US)

(72) Inventors: Keerthi Gopalakrishnan, San Jose, CA (US); Ishan Karanwal, San Franciso, CA (US); Yokila Arora, San Jose, CA (US); Sushant Kumar, San Jose, CA (US); Kannan Achan, Saratoga, CA (US)

(21) Appl. No.: 18/961,783

(22) Filed: Nov. 27, 2024

(51) Int. Cl. H04W 4/021; H04L 41/22

(52) U.S. Cl. CPC H04W 4/021; H04L 41/22

(57) ABSTRACT

Example implementations relate to interface generation including interface elements representative of a co-located resource when a user device is located within a predetermined geofenced area and a corresponding user has historical interactions with the co-located resource. In an example, a request for an interface and location data are received from a user device. The location data corresponds to a location of the user device when the request for the interface was generated. In response to determining the location data is within a predetermined geofenced area, a resource use probability of a resource for the user device is generated using a resource affinity model based at least in part on historical usage of the resource. In response to determining the resource use probability is above a predetermined threshold, instructions are transmitted to the user device that modify the interface to include an interface element representative of a resource usage.

### TECHNICAL FIELD

This application relates generally to automated interface generation, and more particularly, to automated interface generation using location data.

### BACKGROUND

An application on a user device such as a smartphone may display an interactive interface. Such a user device may also be able to obtain information regarding the location of the user device. Such location information may be used in geofencing services such as triggering certain actions associated with the user device in response to being in a particular geographic location.

### BRIEF DESCRIPTION OF THE DRAWINGS

Various examples will be described below with reference to the following figures.

FIG. 1 depicts an example system for interface modification based on location and resource affinity determinations, in accordance with some embodiments.

FIG. 2 depicts an example system for resource affinity model generation and implementation, in accordance with some embodiments.

FIG. 3 depicts a trained deep and cross neural network, in accordance with some embodiments.

FIG. 4 depicts a flow diagram illustrating a method of interface modification based on a resource affinity determination, in accordance with some embodiments.

FIG. 5 depicts an example system with a machine-readable medium that includes instructions for interface modification based on a resource affinity determination, in accordance with some embodiments.

FIG. 6 depicts an example computer system that implements one or more of the disclosed processes, in accordance with some embodiments.

### DETAILED DESCRIPTION

Certain geographic areas provide multiple resources or services associated with a first party (e.g., a vendor or group of vendors). For example, certain geographic areas may offer retail services (e.g., providing a physical store including one or more types of products) and may also offer additional services, such as a resource station (e.g., a fueling station). Although these services may be provided at the same or nearby physical locations, users of one of the services (e.g., retail services) may not be aware of or utilize the other available services located in geoproximity.

Additionally, when users are located within a predetermined physical area, such as within the physical store offering retail services, users may simultaneously interact with digital interfaces associated with the first party, such as interacting with a provided application or website via a mobile user device. Current interface generation processes do not utilize user location to provide interface information regarding additional service opportunities, such as nearby resource use opportunities.

The disclosed systems and methods provide an interface generation process that utilizes user location information for a user device location at the time of an interface request and user interaction history to modify an interface to include elements regarding resource use opportunities provided at geographically close locations. When a request for an interface is received from a user device, location data may be used to determine whether the user device was within a predetermined geofenced area when the request was generated. When the request is generated within the predetermined geofenced area, a resource use probability for at least one resource associated with the geofenced area (e.g., a resource that is at the same or a geographically close location) is generated and, when the probability is above a predetermined threshold, the requested interface is modified to include one or more interface elements that are representative of the resource use opportunity and/or the resource. The modified interface provides the user with additional available service information for resources that are geographically co-located with other physical locations used by the user. The generation of a modified interface specifically when the user device was within the geofenced area and when the corresponding resource use probability is above a predetermined threshold provides higher relevance interfaces to users, reduces processing resources and bandwidth requirements for generating interfaces, and improves user navigation through the interface to find relevant information.

Further, the disclosed systems and methods provide a modified interface that includes elements related to resource use opportunities. Modification of the interface occurs in response to determining that a user device requesting the interface is located within a predetermined geofenced area and is associated with historical use of the corresponding resource. By limiting modification of the interface based on location and historical use, the disclosed systems and methods provide interface elements representative of resource usage specifically to relevant users (e.g., the interface elements may be provided when they are relevant interface elements) Correspondingly, when interface elements regarding resource usage are not relevant, the interface is not modified to avoid transmission of irrelevant interface elements to users. Selective modification of user interfaces reduces computational resource requirements and bandwidth requirements and improves network responsiveness for the corresponding interface.

In various embodiments, a system including a processor and a non-transitory memory storing instructions is disclosed. The instructions, when executed, cause the processor to receive a request for an interface from a user device and receive location data from the user device. The location data corresponds to a location of the user device when the request for the interface was generated. The instructions further cause the processor to determine whether the location data is within a predetermined geofenced area and, in response to determining the location data is within the predetermined geofenced area, generate a resource use probability of a resource for the user device using a resource affinity model based at least in part on historical usage of the resource. The instructions further cause the processor to determine whether the resource use probability is above a predetermined threshold and, in response to determining the resource use probability is above the predetermined threshold, transmit instructions to the user device that modify the interface to include an interface element representative of a resource usage.

In various embodiments, a computer-implemented method is disclosed. The computer-implemented method includes steps of receiving a request for an interface from a user device and receiving location data from the user device. The location data corresponds to a location of the user device when the request for the interface was generated. The computer-implemented method further includes steps of determining whether the location data is within a predetermined geofenced area and, in response to determining the location data is within the predetermined geofenced area, generating a resource use probability of a resource for the user device using a resource affinity model based at least in part on historical usage of the resource. The computer-implemented method further includes steps of determining whether the resource use probability is above a predetermined threshold, and, in response to determining the resource use probability is above the predetermined threshold, transmitting instructions to the user device that modify the interface to include an interface element representative of a resource usage.

In various embodiments, a non-transitory computer-readable medium having instructions stored thereon is disclosed. The instructions, when executed by at least one processor, cause at least one device to perform operations including receiving a request for an interface from a user device and receiving location data from the user device. The location data corresponds to a location of the user device when the request for the interface was generated. The instructions further cause the at least one device to perform operations including determining whether the location data is within a predetermined geofenced area and, in response to determining the location data is within the predetermined geofenced area, generating a resource use probability of a resource for the user device using a resource affinity model based at least in part on historical usage of the resource. The instructions further cause the at least one device to perform operations including determining whether the resource use probability is above a predetermined threshold, and, in response to determining the resource use probability is above the predetermined threshold, transmitting instructions to the user device that modify the interface to include an interface element representative of a resource usage.

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for geolocation-based interface generation and modification. In various embodiments, a request for a user interface is received from a user device. The location of the user device at the time the request is generated is determined. When the user device is located within a predetermined geofenced area, such as a first physical location associated with a first party, the requested interface may be modified to include interface elements representative of resource usage opportunities for geographically co-located resources. As used herein, co-located resources refer to goods or services that are different from the goods or services provided at the first physical location. As one non-limiting example, in some embodiments, when a geolocation of the user device is determined to be within a predetermined geofenced area corresponding to a physical retail store that has a co-located fueling station, the requested user interface may be modified to include interface elements that are representative of fueling opportunities at the fueling station. Co-located resources may be located within or close to the first physical location, e.g., at a second physical location within a predetermined distance of the first physical location.

In some embodiments, a user interface is modified when a user device is located within a predetermined geofenced area and when the user has historically interacted with the corresponding co-located resource. For example, a user device may generate a request for an interface (e.g., an interface request) from within a predetermined geofenced area. The request may be generated by a user interacting with a user device to cause a request for an interface to be generated, such as by interacting with an application on the user device, requesting a webpage or other network interface, etc. The first geofenced area may include, but is not limited to, a retail store or other physical space associated with a first entity. The predetermined geofenced area may be associated with at least one co-located resource. The co-located resource may include, but is not limited to, a fueling station located within or in proximity to the first geofenced area. When the interface request is generated while the user device is within the predetermined geofenced area, the system receiving the request determines whether the user device (or a user associated with the user device) has a likelihood (e.g., a probability above a predetermined threshold) of interacting with the co-located resource above a predetermined threshold. When the likelihood the user interacts with the resource is high (e.g., the probability is equal to or above the threshold), the requested interface is modified to include interface elements that are representative of the co-located resource or representative of use opportunities for the co-located resource.

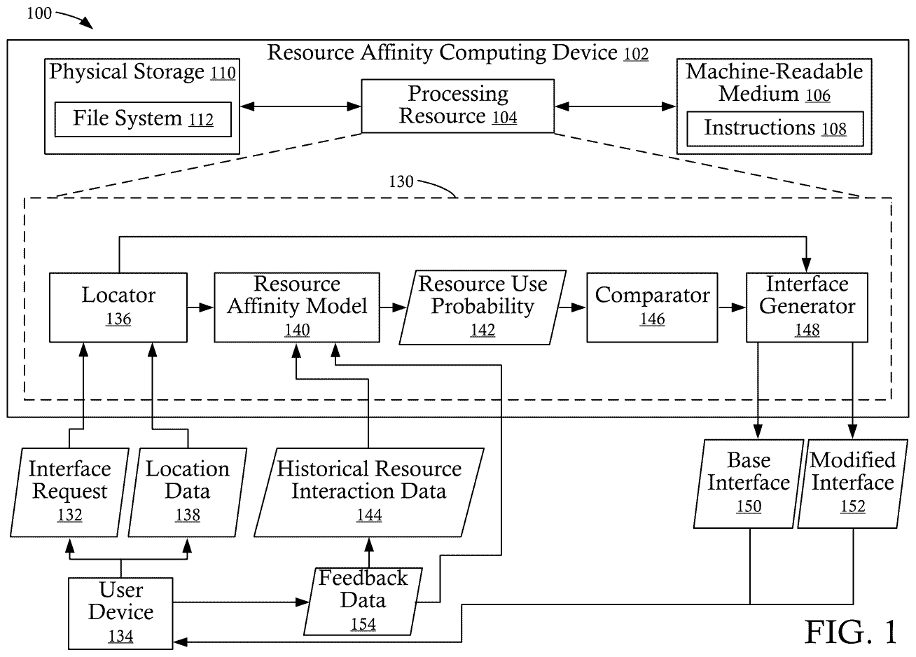

FIG. 1 depicts an example system 100 that provides interface modification based on a resource affinity determination, in accordance with some embodiments. The system 100 includes a resource affinity computing device 102 that receives a request for an interface and generates an interface including at least one interface element representative of a co-located resource when a requesting device is located at or within a predetermined geofenced area and when a user associated with the user device has a predetermined affinity for a co-located resource. The resource affinity computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The resource affinity computing device 102 includes a non-transitory machine-readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine readable medium 106 to perform functions of the resource affinity computing device 102, such as receiving an interface request and/or location data from a user device, determining when a user device is located within a predetermined geofenced area, determining a user resource affinity, and/or modifying a requested interface to include interface elements representative of a co-located resource. The instructions 108 may include instructions for implementing one or more models. In some embodiments, and as will be described further herein below, the resource affinity computing device 102 may execute one or more models, processes, or algorithms, such as a machine learning model, deep learning model, statistical model, etc., (e.g., as implemented as machine readable instructions) to determine user affinity for one or more co-located resources.

The resource affinity computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (e.g., installed) in the resource affinity computing device 102. In some implementations, physical storage 110 may be accessed as a block storage device.

In some cases, the resource affinity computing device 102 may also include a local file system 112 that may be implemented as a layer on top of the physical storage 110. For example, an operating system may be executing on the resource affinity computing device 102 (by virtue of the processing resource 104 executing certain instructions 108 related to the operating system) and the operating system may provide a file system 112 to store data on the physical storage 110.

The resource affinity computing device 102 may be in communication with one or more additional devices over one or more network channels. For example, in various embodiments, the resource affinity computing device 102 may be in communication with a web server, a cloud-based engine including one or more processing devices that may be provisioned for use, a database, a workstation, and/or any other suitable system or device. The resource affinity computing device 102 may similarly be in communication, either directly or indirectly, with one or more user computing devices operatively coupled over the network. The other computing systems may be similar to the resource affinity computing device 102, and may each include at least a processing resource and a machine readable medium.

In some embodiments, the resource affinity computing device 102, such as the processing resource 104, implements an interface generation process 130 that receives a user interface request 132 and generates an interface including at least one interface element representative of a co-located resource when the interface request 132 is generated at or within a predetermined geofenced location and is associated with a user having an affinity for the co-located resource above a predetermined threshold.

In some embodiments, an interface request 132 is received from a user device 134. The user request may include an electronic communication from the user device 134 to the resource affinity computing device 102 and the user device 134 may include a smart phone, connected vehicle interface, mobile device, or the like. The requested interface may be associated with an entity (e.g., a vendor, retailer) that may be further associated with one or more first physical locations. Each of the first physical locations may include, for example, retail locations, service locations, warehouse locations, pickup locations, etc. Each of the first physical locations may be associated with at least one co-located resource location, e.g., a second physical location, at which at least one resource is available, that is within a predetermined distance of the first physical location. For example, a resource location may include a fueling location providing fuel (e.g., gasoline, natural gas, kerosene, propane).

In some embodiments, the interface request 132 is generated via the user device 134 in response to a user interacting with an application on the user device 134, such as a first party-specific application (i.e., an application specific to, provided by, or otherwise associated with a first party, such as a vendor for example), a web browsing application, and/or any other suitable application. For example, the interface request 132 may be generated in response to a user interacting with a first party-specific application that generates one or more user interface screens. As another example, the interface request 132 may be generated in response to a user interacting with a web browsing application to direct the web browsing application to an internet address associated with the first party. Although certain embodiments are discussed herein, it will be appreciated that the interface request 132 may be generated according to any suitable process executed on and/or in conjunction with the user device 134.

In some embodiments, the interface request 132 is received by a locator 136. The locator 136 determines whether the user device 134 was located within a predetermined geofenced area at the time the interface request 132 was generated. For example, a predetermined geofenced area may be defined for each of the first physical locations associated with the first party that have a co-located resource. The predetermined geofenced areas may correspond to a portion of the first physical location, the entirety of the first physical location, and/or an area extending beyond the first physical location. As one non-limiting example, when the first physical location is a retail store associated with the first party, the predetermined geofenced area may correspond to a portion of the retail store, the entirety of the retail store, an area encompassing both the retail store and additional physical space (e.g., a parking lot), and/or an area of predetermined size centered on the retail store. Although specific embodiments are discussed herein, it will be appreciated that the predetermined geofenced area may be defined to include any suitable physical area. Although embodiments are illustrated with the locator 136 incorporated into the resource affinity computing device 102, it will be appreciated that the locator 136 may be incorporated into the user device 134 and/or an additional system (not illustrated).

A co-located resource location associated with the corresponding first physical location may be located within the predetermined geofenced area and/or may be located within a predetermined distance of the predetermined geofenced area. For example, a resource location may be defined as co-located with respect to the first physical location when the resource location is within a predetermined geofenced area defined for the first physical location (e.g., being the resource location is located within a shared lot that encompasses the predetermined geofenced area for the first physical location). As another example, a resource location may be defined as co-located with respect to the first physical location when the resource location is located within a predetermined distance of the outer edge of the predetermined geofenced area. As yet another example, a resource location may be designated as a co-located resource location using one or more additional or alternative processes, such as a manual designation, an automated designation process, etc.

In some embodiments, the locator 136 determines whether the location of the user device 134, at the time the interface request 132 was generated, was within one of the predetermined geofenced areas for any of the first physical locations associated with the first party. For example, the locator 136 may receive location data 138 from the user device 134. The location data 138 may be included as part of the interface request 132 and/or may be provided separately from the interface request 132. In some embodiments, the locator 136 may receive the interface request 132 and generate a location data request (not shown) that is transmitted to the user device 134 and that causes the user device 134 to provide location data 138 to the locator 136. In some embodiments, the user device 134 prompts a user for permission before sending location data 138 to the locator 136.

In some embodiments, the locator 136 compares the location data 138 to each predetermined geofenced area for each of the first physical locations having a co-located resource location. For example, in some embodiments, the one or more predetermined geofenced areas may include retail locations associated with the first party that are each associated with a co-located fueling station. The locator 136 may compare the location data 138 to sets of location data associated with each of the one or more predetermined geofenced areas. The location data may include, but is not limited to, satellite-based position data (e.g., global positioning satellite (GPS) data, global navigation satellite system (GNSS) data, Global Navigation Satellite System (GLONASS) data, BeiDou Navigation Satellite System (BDS) data, Galileo data), cell tower-based location data, network location data, etc.

In some embodiments, when the locator 136 determines the user device 134 was outside of each of the predetermined geofenced areas, the locator 136 forwards the interface request 132 to the interface generator 148. As discussed in greater detail below, when the user device 134 is located outside of the predetermined geofenced areas, the interface generator 148 generates a base interface 150 (e.g., an interface omitting interface elements representative of a resource) for transmission to the user device 134.

In some embodiments, when the locator 136 determines the user device 134 was at or within a predetermined geofenced area at the time the interface request 132 is generated, the locator 136 provides one or more portions of the interface request 132 to a resource affinity model 140. For example, when the locator 136 identifies an overlap between the location data 138 and one of the predetermined geofenced areas associated with a first physical location, the locator 136 may forward the interface request 132 to the resource affinity model 140. As another example, the interface request 132 may be provided from the user device 134 directly to the resource affinity model 140 and processed when a second signal is received from the locator 136 indicating overlap between the location data 138 and a predetermined geofenced area.

In some embodiments, the resource affinity model 140 determines a resource use probability 142 for a user associated with the user device 134. The resource use probability 142 is representative of a likelihood that the user associated with the user device 134 will interact with the co-located resource for the corresponding predetermined geofenced area (e.g., the predetermined geofenced area overlapping with the location data 138) within a predetermined period. For example, where the resource is a fueling station, the resource affinity model 140 may determine a resource use probability 142 for the user interacting with the fueling station within a predetermined period of time (e.g., a predetermined window) from generation of the interface request 132. The resource affinity model 140 may utilize historical resource interaction data 144 representative of historical interactions between a user and a corresponding resource to determine likelihood of the user interacting with the co-located resource. For example, when a user has not historically utilized a co-located resource, e.g., the user has no historical resource interaction data 144, the user affinity may be low (e.g., in an implementation the user affinity may be determined to be zero). As the number of interactions between the user and the resource provided at the co-located resource location increases, the likelihood that a user may interact with the co-located resource may similarly increase.

In some embodiments, the resource affinity model 140 initially determines whether the user associated with the user device 134 has historical resource interaction data 144 with the resource provided at the co-located resource location. When a user has not interacted with the resource provided at the co-located resource location (e.g., a user has not utilized any fueling stations provided by or associated with the first party), the resource affinity model 140 may determine that a user is unlikely to utilize the co-located resource without calculating a resource use probability 142 (e.g., in an implementation the resource affinity model 140 may set the resource use probability to zero where a user has no historical interactions with a co-located resource).

In some embodiments, a resource use probability 142 is calculated for users having a predetermined number of interactions with a co-located resource, e.g., having a predetermined number of historical interactions in the historical resource interaction data 144. For example, a resource use probability 142 may be determined for users having one, two, three, or more interactions with resource locations providing the co-located resource of the corresponding first physical location. As another example, a resource use probability 142 may be determined for users that have interactions with a resource other than the co-located resource that is related to the co-located resource, such as determining a resource use probability 142 for a co-located gasoline resource where the user has one or more interactions with other fuel resources locations, such as kerosene resource locations. Although specific embodiments are discussed herein, it will be appreciated that any suitable thresholds may be applied to determine when to calculate a resource use probability 142.

In some embodiments, the resource use probability 142 is determined for a predetermined period. For example, the resource use probability 142 may be representative of a likelihood of a user interacting with the co-located resource within a predetermined period from generation of the interface request 132. The predetermined period may include, for example, a time window representative of an average time a user spends at the first physical location for each visit to the first physical location, an average time from being located at the first physical location to utilization of the co-located resource, and/or any other suitable period. In some embodiments, the resource use probability 142 is determined for an open-ended period (e.g., no fixed time window) and represents the likelihood of a user interacting with the co-located resource at any point in the future.

In some embodiments, the resource affinity model 140 includes a deep and cross neural network. A deep and cross neural network combines a traditional feed-forward multi-layer perceptron (e.g., a deep network) with a feature-crossing logic at each layer. The deep and cross neural network may receive at least two features and generate at least three weights for each combination of two features. That is, the deep and cross neural network may receive a first quantity of features and apply a second quantity of weights, where the second quantity of weights is greater than the first quantity of features. For example, a deep and cross neural network that receives an input of a first feature and a second feature may be trained to generate a first weight for the first feature, a second weight for the second feature, and a third weight for the cross-relationship between the first feature and the second feature. In some embodiments, a deep and cross neural network generates an output including a single probability score (or value) representative of a likelihood that a user will utilize a co-located resource after a next interface interaction within a predetermined geofenced area.

The resource use probability 142 is provided to a comparator 146 that compares the resource use probability 142 to a predetermined threshold. For example, the comparator 146 may apply a predetermined threshold representative of a high likelihood of a user interacting with the co-located resource. When the comparator 146 determines the resource use probability 142 is above, that is, greater than (or, in some embodiments, above or equal to) the predetermined threshold, the user is considered likely to interact with the corresponding co-located resource. Alternatively, when the resource use probability is below, that is, less than (or, in some embodiments, below or equal to) the predetermined threshold, the user is considered unlikely to interact with the corresponding co-located resource. The comparator 146 provides a likelihood indication to the interface generator 148 indicating whether the user is likely or unlikely to interact with the co-located resource within the predetermined period.

In some embodiments, when the likelihood indication generated by the comparator 146 indicates the user is unlikely to interact with the co-located resource within the predetermined period, the interface generator 148 generates a base interface 150, e.g., an interface that does not have or include interface elements related to the co-located resource. Alternatively, when the likelihood indication generated by the comparator 146 indicates the user is likely to interact with the co-located resource within the predetermined period, the interface generator 148 generates a modified interface 152 including one or more interface elements representative of the co-located resource and/or usage opportunities for the co-located resource, and the modified interface 152 may be provided for display via the first-party specific application on the user device 134.

In some embodiments, the interface elements representative of the co-located resource may include additional details regarding availability of a co-located resource and/or resource usage opportunities. For example, in some embodiments, one or more interface elements representative of the co-located resource may include limited time resource usage opportunities. As another example, in some embodiments, one or more interface elements representative of the co-located resource may include information regarding remaining stock or availability for the co-located resource. Although specific embodiments are discussed herein, it will be appreciated that any suitable information may be provided by the interface elements representative of the co-located resource.

In some embodiments, one or more of the interface elements included in the base interface 150 (e.g., initial interface elements) may be replaced with interface elements representative of the co-located resource to generate the modified interface 152. For example, in some embodiments, one or more initial interface elements representative of items and/or services available at a first location within the predetermined geofenced area (e.g., a retail location) may be replaced or substituted with interface elements representative of the co-located resource, the co-located resource location, and/or resource use opportunities for the co-located resource.

In some embodiments, one or more additional interface elements related to the co-located resource are overlayed and/or added to the base interface 150 to generate the modified interface 152. For example, in some embodiments, one or more overlay or popup interface elements representative of the co-located resource, the co-located resource location, and/or usage opportunities for the co-located resource may be displayed with and/or over the base interface 150 without modifying the underlying base interface 150.

In some embodiments, feedback data 154 regarding interactions with a modified interface 152 and/or a co-located resource may be received, e.g., from user device 134. For example, the feedback data 154 may include an indication of a user interaction (e.g., click-through, close, etc.) with the corresponding interface element. As another example, the feedback data 154 may include data representative of one or more interactions between a user and a co-located resource that occurs after generation of a modified interface 152. The interaction with the co-located resource may occur at the co-located resource location and/or at an alternative resource location not associated with the first physical location. In some embodiments, historical resource interaction data 144 is updated and/or the resource affinity model 140 is retrained based on the feedback data 154.

As one non-limiting example, in some embodiments, the interface generation process 130 generates a modified interface when a user requests an interface (e.g., on a first party specific application) while at a first physical location associated with a co-located fueling station. As discussed above, a locator 136 receives location data for the user device 134 at the time the interface request 132 is generated. When the location data 138 overlaps with a first physical location that is associated with the first party and that is co-located with a fueling station, the resource affinity model 140 determines a likelihood of a user associated with the user device 134 interacting with the co-located fueling station. When the resource use probability 142 is above (or in some embodiments, above or equal to) a predetermined threshold, as determined by the comparator 146, the interface generator 148 generates a modified interface 152 including one or more interface elements representative of the co-located fueling station (e.g., representative of fueling opportunities, the location of the co-located fueling station, etc.). The modified interface 152 may be provided to the user device 134, e.g., via the first-party specific application. A user may interact with an interface element of the modified interface 152 that is representative of the co-located fueling station, and the interaction may generate feedback data 154. Subsequently, the user may interact with a fueling station associated with the first party, e.g., the co-located fueling station and/or another fueling station associated with the first party, to generate additional feedback data 154. When the user device 134 subsequently generates an interface request 132 while located within a predetermined geofenced area, the feedback data 154 may be utilized to generate an updated resource use probability 142 for the corresponding user.

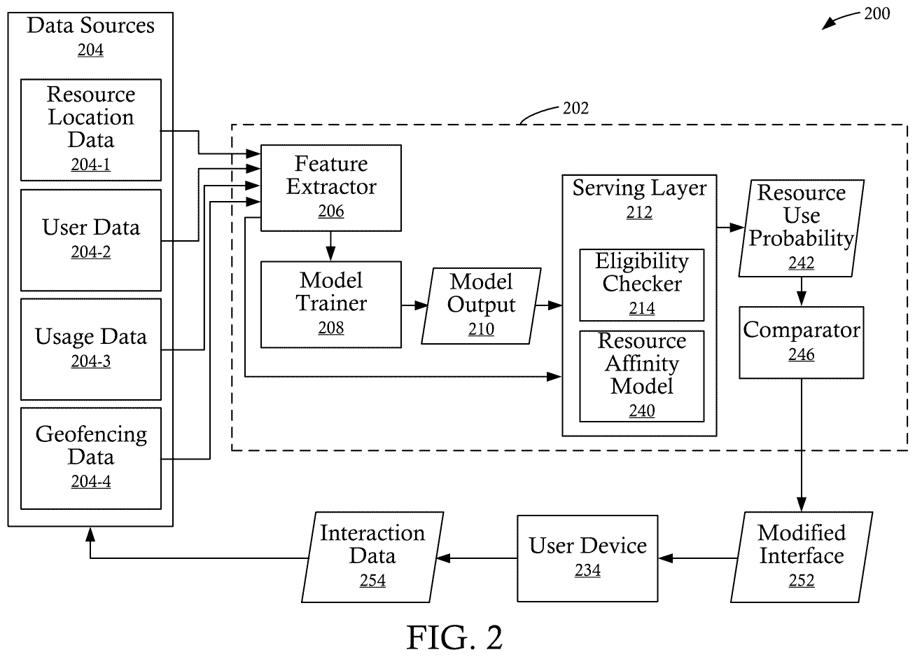

FIG. 2 depicts an example system 200 for resource affinity model generation and implementation, in accordance with some embodiments. The system 200 may be implemented by a computing device, such as the resource affinity computing device 102 illustrated in FIG. 1. The system 200 generates and implements a resource affinity model 240 that determines a likelihood of a user interacting with a co-located resource for an identified predetermined geofenced area.

The system 200 includes a model implementor 202 that receives data elements from one or more data sources 204. The data sources 204 may include, but are not limited to, resource data location data 204-1, user data 204-2, usage data 204-3, and/or geofencing data 204-4. The resource data location data 204-1 may include location data for one or more resources, e.g., one or more potentially co-located resources. The user data 204-2 may include historical and/or current user data, such as user location data for one or more interface requests, user interaction data for one or more resources, one or more indicators regarding a user interaction or interest in a resource, etc. The usage data 204-3 may include historical resource usage data for one or more co-located or potentially co-located resources. For example, usage data 204-3 may include an average time between a user request for an interface at a predetermined geofenced location and interaction with a co-located resource or resource station, an average resource usage for aggregated users, and/or any other suitable information for usage of one or more potentially co-located resources. The geofencing data 204-4 may include predetermined geofenced area data for one or more corresponding physical locations.

In some embodiments, the data elements received from the data sources 204 are received by a feature extractor 206 that extracts features for model training and/or implementation from each of the received data elements. Extracted features may include individual data elements or portions of data elements extracted from each of the data sources 204. In some embodiments, the feature extractor 206 may convert extracted data elements into one or more machine representations, for example, an embedding representation (e.g., numerical or vector representation). Extracted features may include, but are not limited to, location features (e.g., feature representing presence within a predetermined geofenced area), resource feature (e.g., features representing co-located resource), user transaction history, user persona related to a resource (e.g., automative person score for fuel resources), fulfillment features, and user recency features.

The extracted features are provided to a model trainer 208 that applies a model training process to generate a model output 210. The model trainer 208 may apply an iterative model training process to generate a model output 210 representative of a deep and cross neural network. In some embodiments, the model training process generates one or more layers representative of the individual features and cross-relationships between different features. For example, the model training process may generate multiple weights for each combination of features, such as generating weights for each feature and weights representative of each combination of features (e.g., a first weight for a first feature, a second weight for a second feature, and a third weight representative of a cross-relationship between the first feature and the second feature).

In some embodiments, the model output 210 includes a deep and cross neural network that includes one or more feature crossing layers and/or one or more information gates. The deep and cross neural network may generate an output including a single probability score representative of a likelihood that a user will interact with a corresponding co-located resource after a current or next interaction at a first physical location associated with the co-located resource. The model output 210 includes weights, layer definitions, and/or other data that allows implementation of resource affinity model 240 for real-time inferencing.

In some embodiments, the model trainer 208 identifies co-located resources for each predetermined geofenced area based on the resource location data 204-1, the usage data 204-3, and the geofencing data 204-4. For example, the model trainer 208 may identify resource locations based on the resource location data 204-1 that have one or more usages in the usage data 204-3 by users that also have an interface request or other interaction at or within a geofenced area defined in the geofencing data within a predetermined period (e.g., a predetermined time window). In some embodiments, the geofenced data 204-4 may identify resource locations in the resource location data 204-1 that are predetermined as co-located resources.

The model output 210 is provided to a serving layer 212 that performs real-time (e.g., current session) inferencing for received interface requests and location data. The serving layer 212 receives the model output 210 and implements a resource affinity model 240 based on the model output 210. The resource affinity model 240 receives one or more features from the feature extractor 206 for a current interface request and outputs a resource use probability 242 for a user associated with the interface request, as discussed above with respect to FIG. 1.

In some embodiments, the serving layer 212 includes an eligibility checker 214 that determines resource probability eligibility for a user. For example, the eligibility checker 214 may receive one or more features representative of user data 204-2 and/or usage data 204-3. A user may be eligible for generation of a resource use probability 242 when the user has one or more historical interactions with the resource corresponding to the resource affinity model 240. For example, if the resource affinity model 240 determines a likelihood of a user utilizing a fueling station resource, the eligibility checker 214 may limit execution of the resource affinity model 240 to those users that have a predetermined number of historical interactions with a fueling station, e.g., users that have used the first party fueling stations at some prior time. The predetermined number of historical interactions may include any suitable threshold, such as one interaction, two interactions, etc. In embodiments including an eligibility checker 214, the resource use probability 242 is determined by the resource affinity model 240 when the eligibility checker 214 indicates the user is eligible.

The resource use probability 242 is provided to a comparator 246 that determines whether the resource use probability 242 is above (or, in some embodiments, above or equal to) a predetermined threshold. Similar to the system 100 discussed above with respect to FIG. 1, when the comparator 246 determines the resource use probability 242 is above the predetermined threshold, a modified interface 252 is generated including one or more interface elements representative of the co-located resource and/or a co-located resource use opportunity.

The modified interface 252 may be provided to a user device, such as a user device 234 that generated an interface request including location data indicating the user device 234 is at or within a predetermined geofenced area. A user may interact with the user device 234 to generate interaction data 254 representative of one or more user interactions with the modified interface 252, such as one or more interactions with interface elements representative of the co-located resource. In some embodiments, interaction data 254 may be generated when a user interacts with a co-located resource, for example, through the user device 234 (e.g., scanning a loyalty card or other interaction at the co-located resource location) and/or through one or more other channels. The interaction data 254 is provided as additional data elements to the data sources 204 and may be used to train (e.g., re-train) one or more additional iterations of a resource affinity model 240.

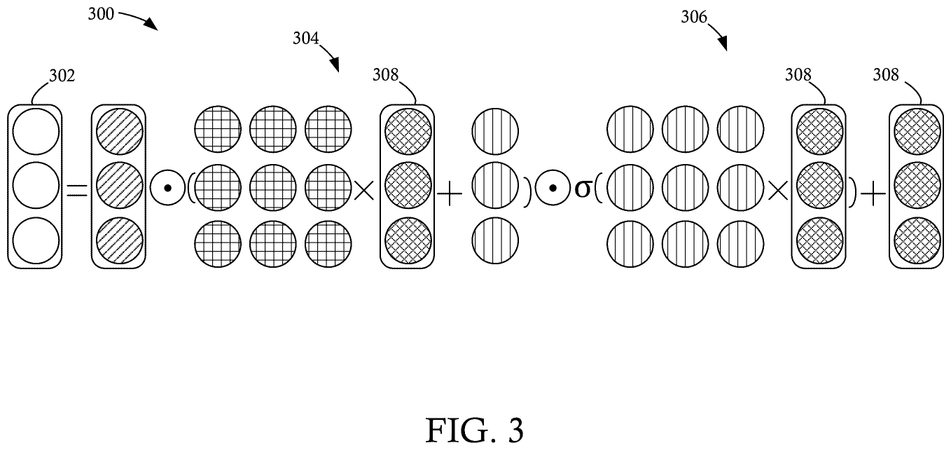

FIG. 3 depicts a trained deep and cross neural network 300, in accordance with some embodiments. The deep and cross neural network 300 may be implemented as part of a system executed by a computing device, such as system 100 including resource affinity computing device 102 illustrated in FIG. 1. The trained deep and cross neural network 300 may be generated by any suitable model training process, such as the model training process described above in conjunction with FIG. 2. Although embodiments are discussed herein with respect to the illustrated embodiment of FIG. 3, it will be appreciated that a trained deep and cross neural network 300 may include additional and/or alternative elements to those illustrated.

The deep and cross neural network 300 generates an output 302 based on a combination of layers each including a feature crossing component 304 and an information gate component 306. An input 308 including one or more features, for example as identified by a feature extractor, are provided to nodes of each of the feature crossing component 304 and the information gate component 306. The output 302 is representative of a likelihood of a user interacting with a co-located resource based on the received inputs 308.

In some embodiments, the deep and cross neural network 300 may be represented by the equation:

$${c}_{l + 1} = {c}_{0} ⊙ ( {W}_{l}^{( c )} \times {c}_{l} + {b}_{l} ) ⊙ σ ( {W}_{l}^{( g )} \times {c}_{l} ) + {c}_{l}$$

where cₗ is the input (e.g., input 308) for a current layer, cₗ₊₁ is the output (e.g., output 302) of the current layer (and input to a subsequent layer),

$${W}_{l}^{( c )}$$

is the feature crossing network (e.g., feature crossing component 304) for the current layer,

$${W}_{l}^{( g )}$$

is the information gate network (e.g., information gate component 306) for the current layer, and σ is a weighting factor. In some embodiments, the deep and cross neural network (e.g., deep and cross neural network 300) is generated by a training process that utilizes a binary label for geofencing data to accompany a resource label and assigns a high weight to the corresponding feature.

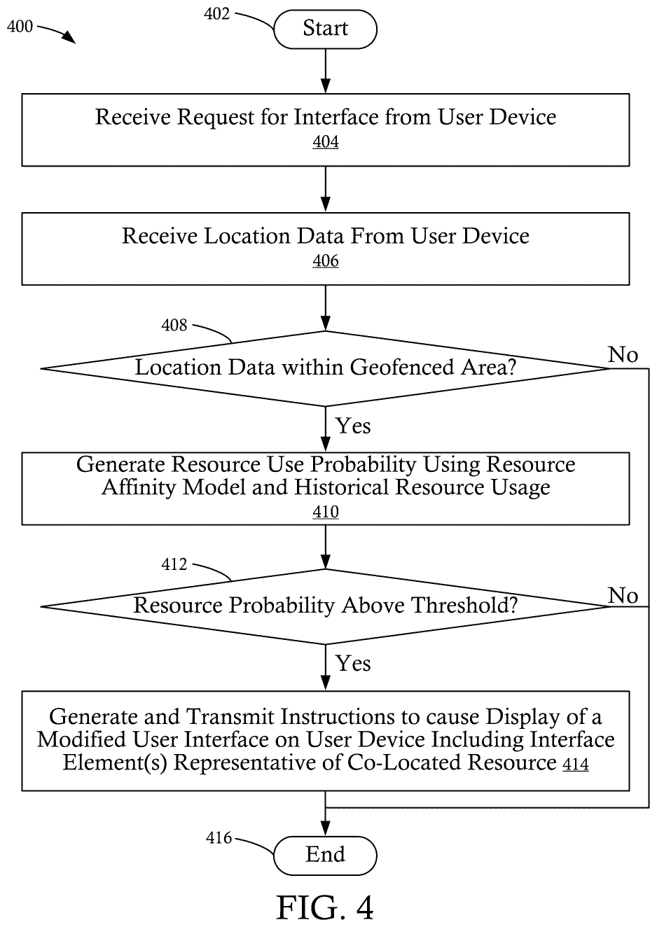

FIG. 4 is a flow diagram depicting an example method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The method shown in FIG. 4 may be implemented in the form of executable instructions stored on machine-readable media and executed by a processing resource and/or in the form of electronic circuitry. For example, aspects of the methods may be described below as being performed by a resource affinity computing device, an example of which may be the interface generation process 130 running on a hardware processing resource 104 of the resource affinity computing device 102 described above. Additionally, other aspects of the methods described below may be described with reference to other elements shown in FIG. 1 for non-limiting illustration purposes.

FIG. 4 depicts a flow diagram illustrating a method 400 of interface modification based on a resource affinity determination, in accordance with some embodiments. Method 400 starts at block 402 and continues to block 404, where a request for an interface is received from a user device. At block 406, location data is received from the user device for a location of the user device at the time the interface request is generated. In some embodiments, blocks 404 and 406 may be combined into a single block and a request for an interface may include location data for the corresponding user device.

At block 408, the location data received from the user device is compared to predetermined geofenced areas corresponding to first physical locations to determine whether the user device was within a predetermined geofenced area when the request for the interface was generated. The location data received from the user device may be compared to each predetermined geofenced area for each of the first physical locations having a co-located resource location to determine whether the user device was located at or within any of the predetermined geofenced areas. For example, in some embodiments, the one or more predetermined geofenced areas may include retail locations associated with a first party that are each associated with a co-located fueling station. The location data may include, but is not limited to, satellite-based position data (e.g., GPS data, GNSS data, GLONASS data, BDS data, Galileo data), cell tower-based location data, network location data, etc.

When the determination at block 408 indicates the user device was not at or within a predetermined geofenced area when the request for the interface was generated (“No” at block 408), the method 400 proceeds to block 416 and method 400 ends. In some embodiments, an interface generation process for generating a base interface may be executed in response to the method 400 ending after block 408. Alternatively, when the determination at block 410 indicates the user device was at or within a predetermined geofenced area (“Yes” at block 408), the method 400 proceeds to block 410 and a resource use probability is generated using a resource affinity model and historical resource usage for the corresponding user.

At block 410, the resource affinity model may include a deep and cross neural network. A deep and cross neural network combines a traditional feed-forward multi-layer perceptron (e.g., a deep network) with a feature-crossing logic at each layer. The deep and cross neural network may receive at least two features and generate at least three weights for each combination of two features. For example, a deep and cross neural network that receives an input of a first feature and a second feature may be trained to generate a first weight for the first feature, a second weight for the second feature, and a third weight for the cross-relationship between the first feature and the second feature. In some embodiments, a deep and cross neural network generates an output including a single probability score (or value) representative of a likelihood that a user will utilize a co-located resource after a next interface interaction within a predetermined geofenced area.

At block 412, the resource use probability generated at block 410 is compared to a predetermined threshold to determine whether the user is likely to interact with a co-located resource (e.g., whether the resource use probability is above a predetermined threshold). When the determination indicates the resource use probability is below a predetermined threshold (e.g., the user is unlikely to interact with the co-located resource, indicated as “No” at block 412), the method 400 proceeds to block 416 and ends. In some embodiments, an interface generation process for generating a base interface may be executed in response to the method 400 ending after block 412. When the determination indicates the resource use probability is above a predetermined threshold (e.g., the user is likely to interact with the co-located resource, indicated as “Yes” at block 412), the method 400 proceeds to block 414.

At block 414, instructions are generated and transmitted to the user device that causes the user device to generate a modified interface that includes one or more interface elements representative of the co-located resource and/or resource use opportunities. The interface elements may include replacement interface elements, additional interface elements, overlaid interface elements, and/or any other suitable interface elements. The interface elements may include information related to use opportunities for the co-located resource, information regarding location of the co-located resource, and/or any other suitable information representative of the co-located resource or resource station. At block 416, the method 400 ends.

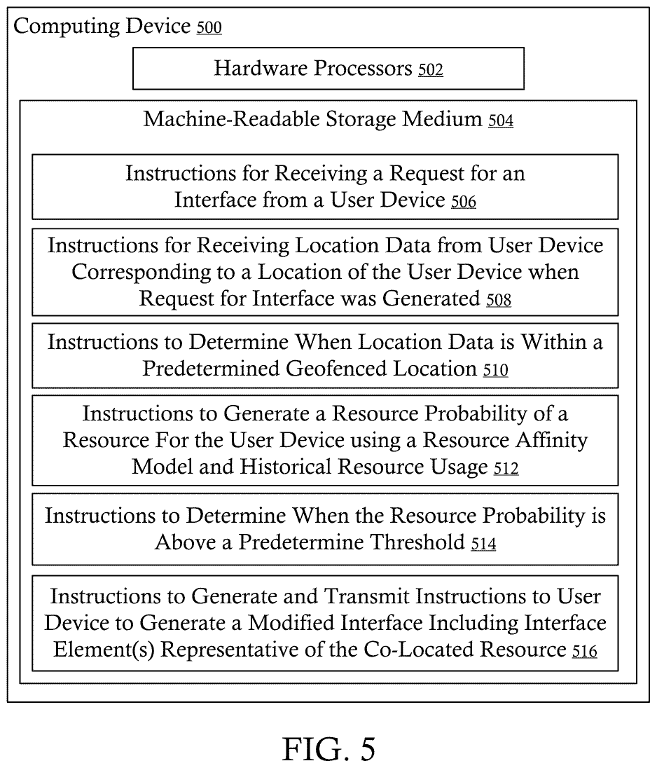

FIG. 5 depicts an example system 500 that includes non-transitory, machine-readable media 504 encoded with example instructions executable by processing resource 502. In some implementations, the system 500 may be useful for implementing aspects of the interface generation process 130 of FIG. 1. For example, the instructions encoded on machine-readable media 504 may be included in instructions 108 of FIG. 1. In some implementations, functionality described with respect to FIG. 1 may be included in the instructions encoded on machine-readable media 504.

The processing resource 502 may include a microcontroller, a microprocessor, central processing unit core(s), an ASIC, an FPGA, and/or other hardware device suitable for retrieval and/or execution of instructions from the machine-readable media 504 to perform functions related to various examples. Additionally or alternatively, the processing resource 502 may include or be coupled to electronic circuitry or dedicated logic for performing some or all of the functionality of the instructions described herein.

The machine-readable media 504 may be any medium suitable for storing executable instructions, such as RAM, ROM, EEPROM, flash memory, a hard disk drive, an optical disc, or the like. In some example implementations, the machine-readable media 504 may be a tangible, non-transitory medium. The machine-readable media 504 may be disposed within the system 500 respectively, in which case the executable instructions may be deemed installed or embedded on the system. Alternatively, the machine-readable media 504 may be a portable (e.g., external) storage medium, and may be part of an installation package.

As described further herein below, the machine-readable media 504 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 5.

With reference to FIG. 5, the machine-readable media 504 includes instructions 506-516. Instructions 506, when executed, cause the processing resource 502 to receive a request for an interface from a user device. Instructions 508, when executed, cause the processing resource 502 to receive location data from the user device for a location of the user device at the time the interface request is generated. In some embodiments, instructions 506 and 508 may be combined into a single instruction and a request for an interface may include location data for the corresponding user device.

Instructions 510, when executed, cause the processing resource 502 to compare received location data to predetermined geofenced areas corresponding to first physical locations to determine whether the user device was within a predetermined geofenced area when the request for the interface was generated. The location data received from the user device may be compared to each predetermined geofenced area for each of the first physical locations having a co-located resource location to determine whether the user device was located at or within any of the predetermined geofenced areas. For example, in some embodiments, the one or more predetermined geofenced areas may include retail locations associated with a first party that are each associated with a co-located fueling station. The location data may include, but is not limited to, satellite-based position data (e.g., GPS data, GNSS data, GLONASS data, BDS data, Galileo data), cell tower-based location data, network location data, etc.).

When the determination indicates the user device was at or within a predetermined geofenced area, instructions 512, when executed, cause the processing resource 502 to generate a resource use probability using a resource affinity model and historical resource usage for the corresponding user. The resource affinity model may include a deep and cross neural network. A deep and cross neural network combines a traditional feed-forward multi-layer perceptron (e.g., a deep network) with a feature-crossing logic at each layer. The deep and cross neural network may receive at least two features and generate at least three weights for each combination of two features. For example, a deep and cross neural network that receives an input of a first feature and a second feature may be trained to generate a first weight for the first feature, a second weight for the second feature, and a third weight for the cross-relationship between the first feature and the second feature. In some embodiments, a deep and cross neural network generates an output including a single probability score (or value) representative of a likelihood that a user will utilize a co-located resource after a next interface interaction within a predetermined geofenced area.

Instructions 514, when executed, cause the processing resource 502 to determine when the resource use probability is above a predetermined threshold. When the determination indicates the resource use probability above a predetermined threshold (e.g., the user is likely to interact with the co-located resource), instructions 514, when executed, cause the processing resource 502 to generate and transmit instructions to the user device that cause the user device to generate a modified interface that includes one or more interface elements representative of the co-located resource and/or resource use opportunities. The interface elements may include replacement interface elements, additional interface elements, overlaid interface elements, and/or any other suitable interface elements. The interface elements may include information related to use opportunities for the co-located resource, information regarding location of the co-located resource, and/or any other suitable information representative of the co-located resource or resource station.

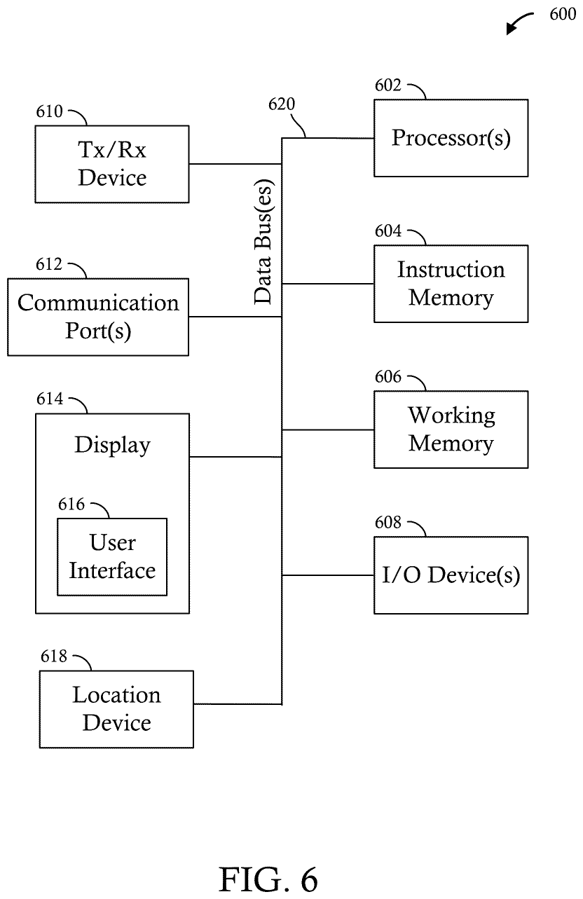

FIG. 6 illustrates a block diagram of a computing device 600, in accordance with some embodiments. Although FIG. 6 is described with respect to certain components shown therein, it will be appreciated that the elements of the computing device 600 may be combined, omitted, and/or replicated. In addition, it will be appreciated that additional elements other than those illustrated in FIG. 6 may be added to the computing device.

As shown in FIG. 6, the computing device 600 may include one or more processing resources 602, instruction memory 604, working memory 606, input/output devices 608, transceiver 610, communication ports 612, display 614, optional location device 618, and/or any other suitable elements each operatively coupled to one or more data buses 620. The data buses 620 allow for communication among the various components. The data buses 620 may include wired, or wireless, communication channels.

The one or more processing resources 602 may include any processing circuitry operable to control operations of the computing device 600. In some embodiments, the one or more processing resources 602 include one or more distinct processors, each having one or more cores (e.g., processing circuits). Each of the distinct processors may have the same or different structure. The one or more processing resources 602 may include one or more central processing units (CPUs), one or more graphics processing units (GPUs), ASICs, digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 602 may also be implemented by a controller, a microcontroller, an ASIC, an FPGA, a programmable logic device (PLD), etc.

In some embodiments, the one or more processing resources 602 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 604 may store instructions that are accessed (e.g., read) and executed by at least one of the one or more processing resources 602. For example, the instruction memory 604 may be a non-transitory, computer-readable storage medium such as a ROM, an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 602 may perform a certain function or operation by executing code, stored on the instruction memory 604, embodying the function or operation. For example, the one or more processing resources 602 may execute code stored in the instruction memory 604 to perform one or more of any function, method, or operation disclosed herein.

Additionally, the one or more processing resources 602 may store data to, and read data from, the working memory 606. For example, the one or more processing resources 602 may store a working set of instructions to the working memory 606, such as instructions loaded from the instruction memory 604. The one or more processing resources 602 may also use the working memory 606 to store dynamic data created during one or more operations. The working memory 606 may include, for example, RAM such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), CAM, polymer memory (e.g., ferroelectric polymer memory), phase-change memory (e.g., ovonic memory), ferroelectric memory, SONOS memory, a removable disk, CD-ROM, any non-volatile memory, or any other suitable memory. Although embodiments are illustrated herein including separate instruction memory 604 and working memory 606, it will be appreciated that the computing device 600 may include a single memory unit that operates as both instruction memory and working memory. Further, although embodiments are discussed herein including non-volatile memory, it will be appreciated that computing device 600 may include volatile memory components in addition to at least one non-volatile memory component.

In some embodiments, the instruction memory 604 and/or the working memory 606 includes an instruction set, in the form of a file for executing various methods, such as methods for generating an interface based on location data and resource use probability, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 602.

The input/output devices 608 may include any suitable device that allows for data input or output. For example, the input/output devices 608 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 610 and/or the communication port(s) 612 allow for communication with a network. For example, if a communication network is a cellular network, the transceiver 610 allows communications with the cellular network. In some embodiments, the transceiver 610 is selected based on the type of the communication network the computing device 600 will be operating in. The one or more processing resources 602 are operable to receive data from, or send data to, a network, via the transceiver 610.

The communication port(s) 612 may include any suitable hardware, software, and/or combination of hardware and software that is capable of coupling the computing device 600 to one or more networks and/or additional devices. The communication port(s) 612 may be arranged to operate with any suitable technique for controlling information signals using a desired set of communications protocols, services, or operating procedures. The communication port(s) 612 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 612 allows for the programming of executable instructions in the instruction memory 604. In some embodiments, the communication port(s) 612 allow for the transfer (e.g., uploading or downloading) of data, such as machine learning model training data.

In some embodiments, the communication port(s) 612 couples the computing device 600 to a network. The network may include local area networks (LAN) as well as wide area networks (WAN) including without limitation internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 610 and/or the communication port(s) 612 utilize one or more communication protocols. Examples of wired protocols may include, but are not limited to, USB communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 614 may be any suitable display and may display the user interface 616. The user interface 616 may enable user interaction with interface elements representative of a co-located resource. For example, the user interface 616 may be a user interface for an application of a network environment operator that allows a user to view and interact with the operator's website. In some embodiments, a user may interact with the user interface 616 by engaging the input/output devices 608. In some embodiments, the display 614 may be a touchscreen, where the user interface 616 is displayed on the touchscreen.

The display 614 may include a screen such as, for example, a Liquid Crystal Display (LCD) screen, a light-emitting diode (LED) screen, an organic LED (OLED) screen, a movable display, a projection, etc. In some embodiments, the display 614 may include a coder/decoder, also known as Codecs, to convert digital media data into analog signals. For example, the visual peripheral output device may include video Codecs, audio Codecs, or any other suitable type of Codec.

The optional location device 618 may be communicatively coupled to a location network and operable to receive position data from the location network. For example, in some embodiments, the location device 618 includes a GPS device that receives position data identifying a latitude and longitude from one or more satellites of a GPS constellation. As another example, in some embodiments, the location device 618 is a cellular device that receives location data from one or more localized cellular towers. Based on the position data, the computing device 600 may determine a local geographical area (e.g., town, city, state) of its position.

In some embodiments, the computing device 600 implements one or more modules or engines, each of which is constructed, programmed, configured, or otherwise adapted, to autonomously carry out a function or set of functions. A module/engine may include a component or arrangement of components implemented using hardware, such as by an ASIC or FPGA, for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementation, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices) that execute an operating system, system programs, and application programs, while also implementing the engine using multitasking, multithreading, distributed (e.g., cluster, peer-peer, cloud) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 600 may be a computer, a workstation, a laptop, a server such as a cloud-based server, or any other suitable device. In some embodiments, the computing device 600 is a server that includes one or more processing units, such as one or more GPUs, one or more CPUs, and/or one or more processing cores. The computing device 600 may, in some embodiments, execute one or more virtual machines. In some embodiments, processing resources (e.g., capabilities) of the computing device 600 are offered as a cloud-based service (e.g., cloud computing).

Although embodiments are illustrated herein including certain systems and/or devices, it will be appreciated that additional systems, servers, storage mechanisms, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Identifying interface elements representative of a co-located resource can be burdensome and time consuming for users, especially if users are unaware of the co-located resources or are utilizing interfaces for interactions unrelated to the co-located resources. Systems including trained resource affinity models, as disclosed herein, significantly reduce this problem, allowing systems to automatically present interface elements representative of co-located resources to users when such interface elements are relevant. For example, in some embodiments described herein, when a user is presented with interface elements representative of a co-located resource, each interface element includes, or is in the form of, a link to an interface page for the co-located resource. Each generated interface element thus serves as a programmatically selected navigational shortcut to an interface page, allowing a user to bypass the navigational structure of the interface. Beneficially, programmatically identifying when interface elements representative of co-located resources are relevant and presenting navigation shortcuts may improve relevance of the provided interface to a user. This may be particularly beneficial for computing devices with small screens, where fewer interface elements are displayed to a user at a time and thus navigation of larger volumes of data is more difficult.

It will be appreciated that resource use probability determinations as disclosed herein, particularly on large datasets intended to be used with co-located resources, is made possible with the aid of computer-assisted machine-learning algorithms and techniques, such as the disclosed resource affinity model. In some embodiments, machine learning processes including resource affinity models are used to perform operations that cannot practically be performed by a human, either mentally or with assistance, such as identifying a probability representative of a likelihood of a user interacting with a co-located resource based on location data received from a user device and historical resource interaction data. It will be appreciated that a variety of machine learning techniques can be used alone or in combination to generate a resource affinity model, such as a deep and cross neural network techniques.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions that, when executed, cause the processor to:
receive a request for an interface from a user device;
receive location data from the user device, wherein the location data corresponds to a location of the user device when the request for the interface was generated;
determine whether the location data is within a predetermined geofenced area;
in response to determining the location data is within the predetermined geofenced area, generate a resource use probability of a resource for the user device using a resource affinity model based at least in part on historical usage of the resource;
determine whether the resource use probability is above a predetermined threshold; and
in response to determining the resource use probability is above the predetermined threshold, transmit instructions to the user device that modify the interface to include an interface element representative of a resource usage.

2. The system of claim 1, wherein the resource affinity model comprises a deep and cross neural network.

3. The system of claim 1, wherein the resource affinity model receives a first quantity of features and applies a second quantity of weights to the first quantity of features, wherein the second quantity of weights is greater than the first quantity of features.

4. The system of claim 1, wherein the historical usage of the resource includes at least one resource usage at a resource location associated with the predetermined geofenced area within a predetermined window from a prior request for the interface.

5. The system of claim 1, wherein the interface element is selected from a plurality of interface elements based on historical user behavior.

6. The system of claim 1, wherein the resource use probability is generated in response to determining the location data is within a predetermined geofenced area and determining the user device is associated with historical resource usage.

7. The system of claim 1, wherein the instructions cause the processor to:
receive feedback for the interface element from the user device;
generate a training set including the feedback;
train an updated resource affinity model based at least in part on the training set; and
receive a second request for an interface from the user device, wherein a second resource use probability of the resource is generated by the updated resource affinity model.

8. A computer-implemented method, comprising:
receiving a request for an interface from a user device;
receiving location data from the user device, wherein the location data corresponds to a location of the user device when the request for the interface was generated;
determining whether the location data is within a predetermined geofenced area;
in response to determining the location data is within the predetermined geofenced area, generating a resource use probability of a resource for the user device using a resource affinity model based at least in part on historical usage of the resource;
determining whether the resource use probability is above a predetermined threshold; and
in response to determining the resource use probability is above the predetermined threshold, transmitting instructions to the user device that modify the interface to include an interface element representative of a resource usage.

9. The computer-implemented method of claim 8, wherein the resource affinity model comprises a deep and cross neural network.

10. The computer-implemented method of claim 8, wherein the resource affinity model receives a first quantity of features and applies a second quantity of weights to the first quantity of features, wherein the second quantity of weights is greater than the first quantity of features.

11. The computer-implemented method of claim 8, wherein the historical usage of the resource includes at least one resource usage at a resource location associated with the predetermined geofenced area within a predetermined window from a prior request for the interface.

12. The computer-implemented method of claim 8, wherein the interface element is selected from a plurality of interface elements based on historical user behavior.

13. The computer-implemented method of claim 8, wherein the resource use probability is generated in response to determining the location data is within the predetermined geofenced area and determining the user device is associated with historical resource usage.

14. The computer-implemented method of claim 8, comprising:
receiving feedback for the interface element from the user device;
generating a training set including the feedback;
training an updated resource affinity model based at least in part on the training set; and
receiving a second request for an interface from the user device, wherein a second resource use probability of the resource is generated by the updated resource affinity model.

15. A non-transitory computer-readable medium having instructions stored thereon, wherein the instructions, when executed by at least one processor, cause at least one device to perform operations comprising:
receiving a request for an interface from a user device;
receiving location data from the user device, wherein the location data corresponds to a location of the user device when the request for the interface was generated;
determining whether the location data is within a predetermined geofenced area;
in response to determining the location data is within the predetermined geofenced area, generating a resource use probability of a resource for the user device using a resource affinity model based at least in part on historical usage of the resource;
determining whether the resource use probability is above a predetermined threshold; and
in response to determining the resource use probability is above the predetermined threshold, transmitting instructions to the user device that modify the interface to include an interface element representative of a resource usage.

16. The non-transitory computer-readable medium of claim 15, wherein the resource affinity model comprises a deep and cross neural network.

17. The non-transitory computer-readable medium of claim 15, wherein the resource affinity model receives a first quantity of features and applies a second quantity of weights to the first quantity of features, wherein the second quantity of weights is greater than the first quantity of features.

18. The non-transitory computer-readable medium of claim 15, wherein the historical usage of the resource includes at least one resource usage at a resource location associated with the predetermined geofenced area within a predetermined window from a prior request for the interface.

19. The non-transitory computer-readable medium of claim 15, wherein the interface element is selected from a plurality of interface elements based on historical user behavior.

20. The non-transitory computer-readable medium of claim 15, wherein the resource use probability is generated in response to determining the location data is within the predetermined geofenced area and determining the user device is associated with historical resource usage.
